(19) United States
(12) Patent Application Publication
(10) Pub. No.: US 2023/0281630 A1
(43) Pub. Date: Sep. 7, 2023

(54) TOKEN EVENT WALLET FOR PREVENTING MISDEMEANOR BEHAVIOR DURING EVENTS

(71) Applicants: Marwan H. Almehmadi, Riyadh (SA); Ahmad H. Almehmadi, Jeddah (SA)

(72) Inventors: Marwan H. Almehmadi, Riyadh (SA); Ahmad H. Almehmadi, Jeddah (SA)

(21) Appl. No.: 18/106,570

(22) Filed: Feb. 7, 2023

Related U.S. Application Data
(60) Provisional application No. 63/315,095, filed on Mar. 1, 2022.

(51) Int. Cl. G06Q 20/40; G06Q 20/36; G06Q 20/04; G06Q 20/38

(52) U.S. Cl. CPC G06Q 20/4016; G06Q 20/367; G06Q 20/0457; G06Q 20/389

(57) ABSTRACT

A system and method for preventing misdemeanor behavior during events are disclosed. The method includes receiving registration details of one or more users attending one or more events for registering the one or more users to a token event wallet and receiving payment from one or more sources associated with the one or more users for purchasing one or more token tickets of the one or more events. Further, the method includes purchasing the one or more token tickets from an event channel using the token event wallet and outputting the one or more token tickets on user interface screen of one or more electronic devices associated with the one or more users when the one or more token tickets are successfully bought. The method includes receiving merchandise information and linking the merchandise information with the one or more token tickets of the one or more users.

### FIELD OF INVENTION

Embodiments of a present disclosure relate to event management and more particularly to a token event wallet for preventing misdemeanor behavior during events.

### BACKGROUND

Generally, most consumers typically use paper tickets or e-tickets for entry to a specific event, such as a music concert, cinema and the like. For example, the tickets for events may be bought from online ticket sellers and the bought tickets are received by the consumers via e-mail or text. The consumers generally show the received tickets to ticket checker on electronic devices, such as smartphone, to enter the event. Further, the consumers frequently buy multiple products at the events, such as food, beverages, mugs, merchandise and the like. However, the consumers may cause misdemeanour behaviour by throwing the bought multiple products, and the like. The misdemeanour behaviour may disrupt the ongoing event or may even cause some serious consequences. Thus, it is very essential to track each of the consumers to maintain dignity during the event and take immediate action for any misdemeanour behaviour. However, conventional methods of tracking the consumers require expensive solutions like camera placements and manpower. Thus, the conventional methods are expensive and consumes a lot of time.

Hence, there is a need for a token event wallet for preventing misdemeanor behavior during events in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a token event wallet for preventing misdemeanor behavior during events is disclosed. The token event wallet includes one or more hardware processors and a memory coupled to the one or more hardware processors. The memory includes a plurality of modules in the form of programmable instructions executable by the one or more hardware processors. The plurality of modules include a registration details receiver module configured to receive registration details of one or more users attending one or more events for registering the one or more users to a token event wallet. The registration details include name, address, age, contact number, verification document and email address of the one or more users. The token event wallet is developed using block chain technology. The plurality of modules also include a payment receiving module configured to receive payment from one or more sources associated with the one or more users for purchasing one or more token tickets of the one or more events upon successful registration of the one or more users to the token event wallet. The one or more sources include bank account, debit card, credit card, apple-pay and google pay. Further, the plurality of modules include a ticket purchasing module configured to purchase the one or more token tickets from an event channel using the token event wallet based on the registration details and one or more policy parameters upon successful payment transaction. The one or more policy parameters include one or more age restrictions, one or more event policies and one or more blacklist restrictions. The plurality of modules further include a data outputting module configured to output the one or more token tickets on user interface screen of one or more electronic devices associated with the one or more users when the one or more token tickets are successfully bought. The plurality of modules further include a merchandise information receiver module configured to receive merchandise information via a merchandise barcode when the one or more users purchase the merchandise during the one or more events by using the token event wallet. The merchandise information includes name of merchandise, serial number, ticket number, cost, time and shop name. Furthermore, the plurality of modules further include a merchandise association module configured to link the merchandise information with the one or more token tickets of the one or more users for preventing misdemeanor behavior during the one or more events.

In accordance with another embodiment of the present disclosure, a method for preventing misdemeanor behavior during events is disclosed. The method includes receiving registration details of one or more users attending one or more events for registering the one or more users to a token event wallet. The registration details include name, address, age, contact number, verification document and email address of the one or more users. The token event wallet is developed using block chain technology. Further, the method includes receiving payment from one or more sources associated with the one or more users for purchasing one or more token tickets of the one or more events upon successful registration of the one or more users to the token event wallet. The one or more sources include bank account, debit card, credit card, apple-pay and google pay. Furthermore, the method includes purchasing the one or more token tickets from an event channel using the token event wallet based on the registration details and one or more policy parameters upon successful payment transaction. The one or more policy parameters include one or more age restrictions, one or more event policies and one or more blacklist restrictions. The method further includes outputting the one or more token tickets on user interface screen of one or more electronic devices associated with the one or more users when the one or more token tickets are successfully bought. The method includes receiving merchandise information via a merchandise barcode when the one or more users purchase the merchandise during the one or more events by using the token event wallet. The merchandise information includes name of merchandise, serial number, ticket number, cost, time and shop name. The method also includes linking the merchandise information with the one or more token tickets of the one or more users for preventing misdemeanor behavior during the one or more events.

In accordance with yet another embodiment of the present disclosure, non-transitory computer-readable storage medium having instructions stored thereon that, when executed by a hardware processor, cause the hardware processor to prevent misdemeanor behavior during events. The hardware processor receives registration details of one or more users attending one or more events for registering the one or more users to a token event wallet. The registration details include name, address, age, contact number, verification document and email address of the one or more users. The token event wallet is developed using block chain technology. Further, the hardware processor receives payment from one or more sources associated with the one or more users for purchasing one or more token tickets of the one or more events upon successful registration of the one or more users to the token event wallet. The one or more sources include bank account, debit card, credit card, apple-pay and google pay. Furthermore, the hardware processor purchases the one or more token tickets from an event channel using the token event wallet based on the registration details and one or more policy parameters upon successful payment transaction. The one or more policy parameters include one or more age restrictions, one or more event policies and one or more blacklist restrictions. The hardware processor outputs the one or more token tickets on user interface screen of one or more electronic devices associated with the one or more users when the one or more token tickets are successfully bought. The hardware processor receives merchandise information via a merchandise barcode when the one or more users purchase the merchandise during the one or more events by using the token event wallet. The merchandise information includes name of merchandise, serial number, ticket number, cost, time and shop name. The hardware processor links the merchandise information with the one or more token tickets of the one or more users for preventing misdemeanor behavior during the one or more events.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary smart ticket wallet platform for preventing misdemeanor behavior during events is disclosed, in accordance with an embodiment of the present disclosure;

FIG. 2 is a block diagram illustrating an exemplary token event wallet, such as those shown in FIG. 1, capable of preventing misdemeanor behavior during the events, in accordance with an embodiment of the present disclosure;

FIG. 3 is a process flow diagram illustrating an exemplary method for purchasing ticket and merchandise through token wallet, in accordance with an embodiment of the present disclosure;

FIG. 4 is a pictorial depiction of an exemplary architecture transaction design in smart ticket wallet platform, in accordance with an embodiment of the present disclosure;

FIG. 5 is a pictorial depiction of an exemplary operation of the token event wallet capable of preventing misdemeanor behavior during the events, in accordance with an embodiment of the present disclosure;

FIG. 6 is a pictorial depiction of an exemplary operation of the token event wallet capable of preventing misdemeanor behavior during the events, in accordance with another embodiment of the present disclosure;

FIG. 7 is a pictorial depiction of an exemplary operation of the token event wallet capable of preventing misdemeanor behavior during the events, in accordance with yet another embodiment of the present disclosure; and

FIG. 8 is a process flow diagram illustrating an exemplary method for preventing misdemeanor behavior during the events in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

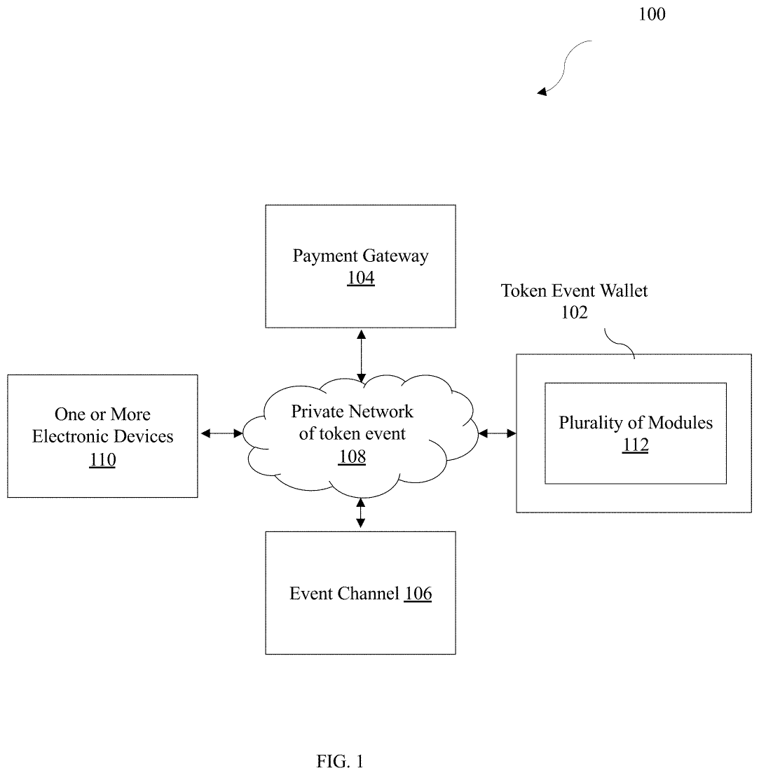

Referring now to the drawings, and more particularly to FIG. 1 through FIG. 8, where similar reference characters denote corresponding features consistently throughout the figures, there are shown preferred embodiments and these embodiments are described in the context of the following exemplary system and/or method.

FIG. 1 is a block diagram illustrating an exemplary smart ticket wallet platform 100 for preventing misdemeanor behavior during one or more events is disclosed, in accordance with an embodiment of the present disclosure. According to FIG. 1, the smart ticket wallet platform 100 includes a token event wallet 102 communicatively coupled to payment gateways 104 and an event channel 106 via a network 108. In an embodiment of the present disclosure, the token event wallet 102 is a smart ticket wallet for one or more events, such as concerts, sports and the like acting as a middleware between the event channel 106 and the payment gateways 104 developed using blockchain technology. Further, the smart ticket wallet platform 100 includes one or more electronic devices 110 associated with one or more users communicatively coupled to the token event wallet 102 via the network 108. The one or more users may use the one or more electronic devices 110 to purchase one or more token tickets from the event channel 106 and receive the one or more token tickets on user interface screen the of the one or more electronic devices 110 when the one or more token tickets are successfully bought. In an exemplary embodiment of the present disclosure, the network 108 may be internet. The token event wallet 102 is a blockchain based system. In an exemplary embodiment of the present disclosure, the one or more electronic devices 110 may include a laptop computer, desktop computer, tablet computer, smartphone, wearable device, smart watch and the like.

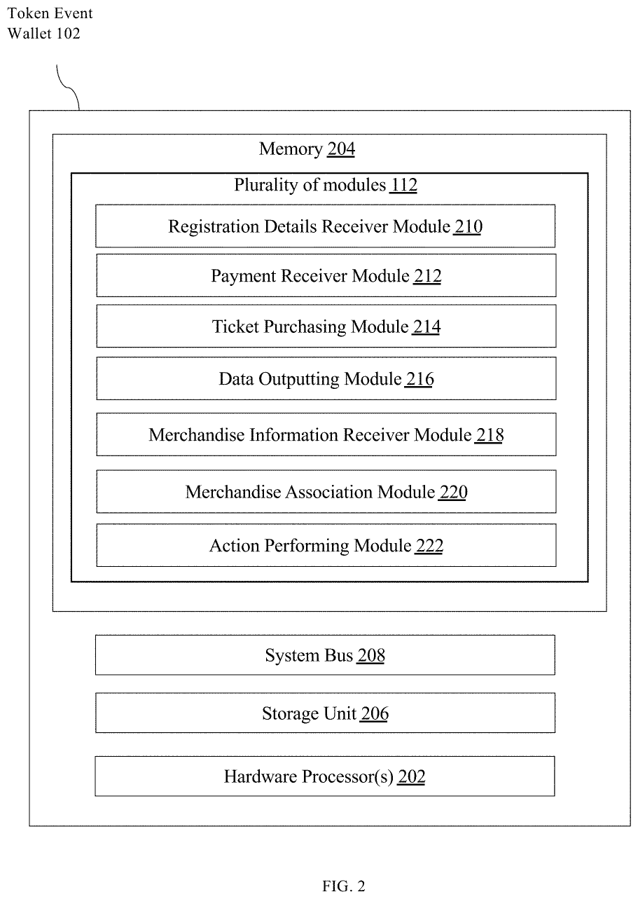

Further, the one or more electronic devices 110 include a web browser, a mobile application or a combination thereof to access the token event wallet 102 via the network 108. In an embodiment of the present disclosure, the one or more electronic devices 110 may use a web application through the web browser to access the token event wallet 102. The mobile application may support android platforms, IOS platforms or both. The token event wallet 102 includes a plurality of modules 112. Details on the plurality of modules 112 have been elaborated in subsequent paragraphs of the present description with reference to FIG. 2.

In an embodiment of the present disclosure, the token event wallet 102 receives registration details of the one or more users attending the one or more events for registering the one or more users to the token event wallet 102. The token event wallet 102 receives payment from one or more sources associated with the one or more users for purchasing the one or more token tickets of the one or more events upon successful registration of the one or more users to the token event wallet 102. Further, the token event wallet 102 purchases the one or more token tickets from the event channel 106 based on the registration details and one or more policy parameters upon successful payment transaction. The token event wallet 102 further outputs the one or more token tickets on user interface screen of the one or more electronic devices 110 associated with the one or more users when the one or more token tickets are successfully bought. The token event wallet 102 receives merchandise information via a merchandise barcode when the one or more users purchase the merchandise during the one or more events by using the token event wallet 102. Furthermore, the token event wallet 102 links the merchandise information with the one or more token tickets of the one or more users for preventing misdemeanor behavior during the one or more events.

FIG. 2 is a block diagram illustrating an exemplary token event wallet 102, such as those shown in FIG. 1, capable of preventing misdemeanor behavior during the events, in accordance with an embodiment of the present disclosure. The token event wallet 102 comprises one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 112 in the form of programmable instructions executable by the one or more hardware processors 202. Further, the plurality of modules 112 includes a registration details receiver module 210, a payment receiving module 212, a ticket purchasing module 214, a data outputting module 216, a merchandise information receiver module 218, a merchandise association module 220 and an action performing module 222.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 112 stored in the form of machine-readable instructions on any of the above-mentioned storage media and may be in communication with and executed by the one or more hardware processors 202.

The storage unit 206 may be a cloud storage or a local file directory within a remote server.

The storage unit 206 may store the registration details, the one or more policy parameters and the merchandise information.

The registration details receiver module 210 is configured to receive the registration details of the one or more users attending the one or more events for registering the one or more users to the token event wallet 102. In an embodiment of the present disclosure, the one or more users are users who desires to attend the one or more events. In an exemplary embodiment of the present disclosure, the one or more events corresponds to concerts, sports and the like. For example, the registration details include name, address, age, contact number, verification document, email address of the one or more users and the like. In an embodiment of the present disclosure, the token event wallet 102 is a smart ticket wallet for the one or more events which acts as a middleware between the event channel 106 and the payment gateways 104. The token event wallet 102 is developed using the blockchain technology.

The payment receiving module 212 is configured to receive payment from the one or more sources associated with the one or more users for purchasing one or more token tickets of the one or more events upon successful registration of the one or more users to the token event wallet 102. In an embodiment of the present disclosure, the one or more sources include bank account, debit card, credit card, apple-pay, google pay and the like.

The ticket purchasing module 214 is configured to purchase the one or more token tickets from the event channel 106 using the token event wallet 102 based on the registration details and the one or more policy parameters upon successful payment transaction. In an embodiment of the present disclosure, the one or more policy parameters include one or more age restrictions, one or more event policies and one or more blacklist restrictions. For example, the one or more age restriction may be that only 18+ crowd is allowed. Further, the one or more event policies may be that only females are allowed. Furthermore, the one or more blacklist restrictions may be that if a user is facing demeanour charges, he is not allowed to participate in the event.

The data outputting module 216 is configured to output the one or more token tickets on user interface screen of the one or more electronic devices 110 associated with the one or more users when the one or more token tickets are successfully bought. The one or more users may show the outputted one or more token tickets at entrance to enter the one or more events. In an exemplary embodiment of the present disclosure, the one or more electronic devices 110 may include a laptop computer, desktop computer, tablet computer, smartphone, wearable device, smart watch and the like.

The merchandise information receiver module 218 is configured to receive the merchandise information via a merchandise barcode when the one or more users purchase the merchandise during the one or more events by using the token event wallet 102. In an embodiment of the present disclosure, the merchandise barcode is tagged on the merchandise, such that the shopkeeper scans the merchandise barcode to retrieve the merchandise information. The merchandise information includes name of merchandise, serial number, ticket number, cost, time, shop name and the like. In an exemplary embodiment of the present disclosure, the merchandise may be a bottle, mug, shoes, and the like.

The merchandise association module 220 is configured to link the merchandise information with the one or more token tickets of the one or more users for preventing misdemeanor behavior during the one or more events. In an embodiment of the present disclosure, the merchandise barcode of the merchandise bought during the event may be linked with ticket barcode to identify identity of a user in case of any misdemeanor. For example, the misdemeanor behavior may be throwing a plastic bottle or shoe on stage. For example, when a user throws a plastic bottle on the stage, the token event wallet 102 may easily identify identity of the user who purchased the bottle, by retrieving the merchandise information as it is already correlated with token ticket of the user. Further, merchandise purchased by a token ticket owner at the event may also be easily identified as it is linked to the token ticket.

Further, the action performing module 222 is configured to perform one or more actions upon detecting users who performed misdemeanor behavior based on gravity of situation. In an exemplary embodiment of the present disclosure, the one or more actions include blacklisting the users, handling the users to respective police department and the like. For example, the detected users are blacklisted or may be handled to respective police department. Further, the one or more users may also sell the bough one or more token tickets by using the token event wallet 102.

Embodiments of the application further provide a non-transitory computer-readable storage medium, in which a computer program is stored. When executed by the processor, the computer program may prevent misdemeanor behavior during the events.

The non-transitory computer-readable storage medium may be any combination of one or more computer-readable media. The computer-readable medium may be a computer-readable signal medium or a computer-readable storage medium. The computer-readable storage medium may be, but is not limited to, for example, an electrical, magnetic, optical, electromagnetic, infrared or semiconductor system, device or apparatus or any combination thereof. More specific examples (non-exhaustive list) of the computer-readable storage medium include an electrical connector with one or more wires, a portable computer disk, a hard disk, a RAM, a ROM, an Erasable Programmable ROM (EPROM) or a flash memory, an optical fiber, a portable CD-ROM, an optical storage device, a magnetic storage device, or any proper combination thereof. In the application, the computer-readable storage medium may be any tangible medium including or storing a program that may be used by or in combination with an instruction execution system, device, or apparatus.

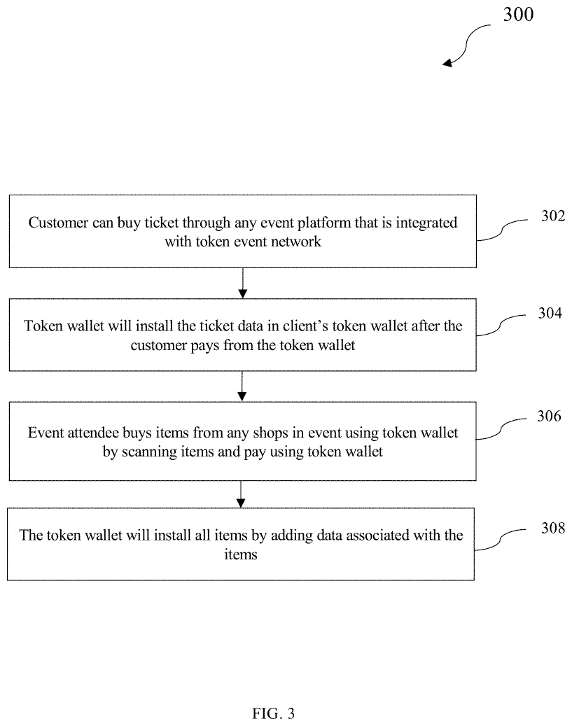

FIG. 3 is a process flow diagram illustrating an exemplary method for purchasing ticket and merchandise through token wallet, in accordance with an embodiment of the present disclosure. At step 302, customer can buy ticket trough any event platform that is integrated with token event network. Further, at step 304, token wallet will install the ticket data in client's token wallet after the customer pays from the token wallet, such as ID, name of client, Token Number, seat, cost of ticket and the like. At step 306, event attendee buys items from any shops in event using token wallet by scanning items and pay using token wallet. In an embodiment of the present disclosure, only the event attendee can buy items from any shops in event using token wallet by scanning items and pay using token wallet. At step 308, the token wallet will install all items by adding data associated with the items. In an exemplary embodiment of the present disclosure, the data associated with the items include items information, shops name, time, cost and the like.

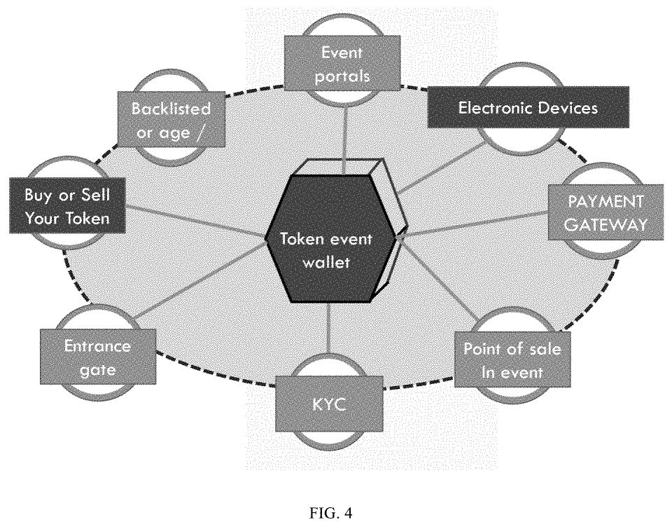

FIG. 4 is a pictorial depiction of an exemplary architecture transaction design in smart ticket wallet platform 100, in accordance with an embodiment of the present disclosure. The token event wallet 102 is associated with event portals, payment gateways 104, point of scale in event, Know Your Client (KYC), entrance gate, the one or more electronic devices 110, buy or sell token ticket, blacklisted or age restriction and the like, as shown in FIG. 4.

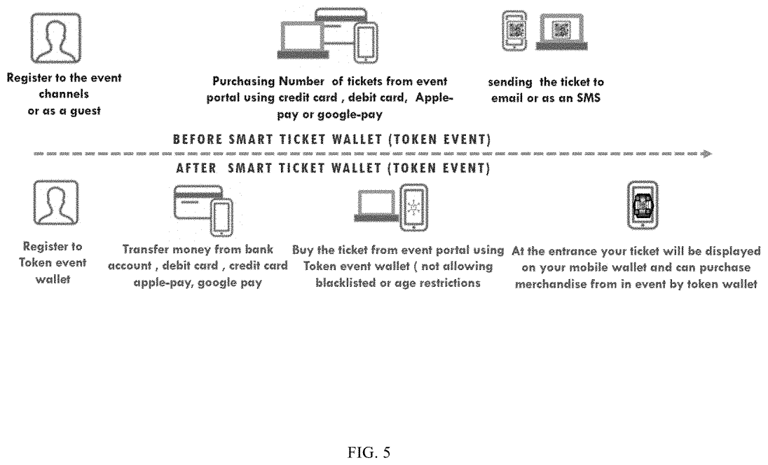

FIG. 5 is a pictorial depiction of an exemplary operation of the token event wallet 102 capable of preventing misdemeanor behavior during the events, in accordance with another embodiment of the present disclosure. In an embodiment of the present disclosure, before smart ticket wallet i.e., token event wallet 102, the one or more users may require to register to the event channel 106 or as a guest. Further, the one or more users are required to purchase number of tickets from event portal using credit card, debit card, Apple-pay, google-pay and the like. Furthermore, the tickets are sent via email, SMS and the like.

In an embodiment of the present disclosure, after the smart ticket wallet, now the one or more users registered to token event wallet 102. Further, the money is transferred from bank account, debit card, credit card, apple-pay, google pay and the like. Furthermore, the one or more token tickets are bought from event portal using token event wallet 102 based on the one or more policy parameters, such as the one or more age restrictions, the one or more event policies and the one or more blacklist restrictions. In an embodiment of the present disclosure, the smart ticket wallet bans buying tickets for those who are on the blacklist or any polices in event channel 106. Further, at the entrance the one or more token tickets may be displayed on mobile wallet. The one or more users may also purchase merchandise during the event by token wallet.

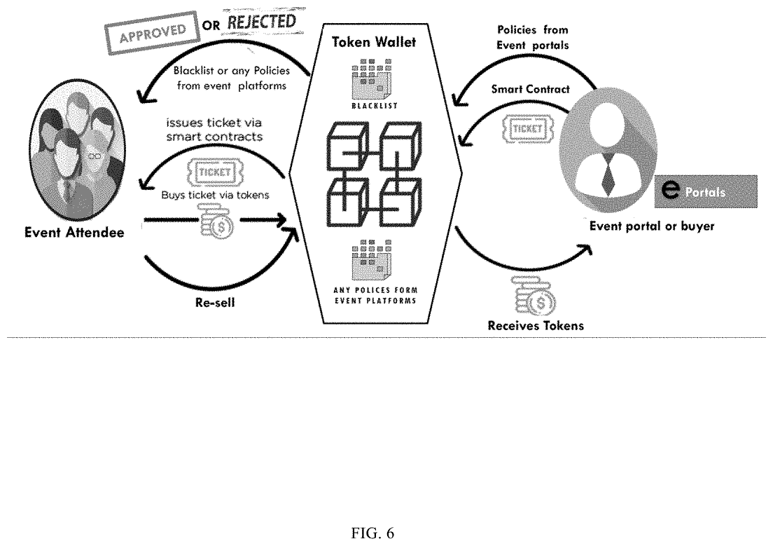

FIG. 6 is a pictorial depiction of an exemplary operation of the token event wallet 102 capable of preventing misdemeanor behavior during the events, in accordance with another embodiment of the present disclosure. An event attendee requests to buy tickets via tokens or re-sells the already bought tickets. Further, the policies are received from the event portals. The tickets are issued via smart contracts or the tickets are not issued due to blacklist or any policies from the event platforms. When the tickets are issues via the smart contracts, the event portals receive tokens.

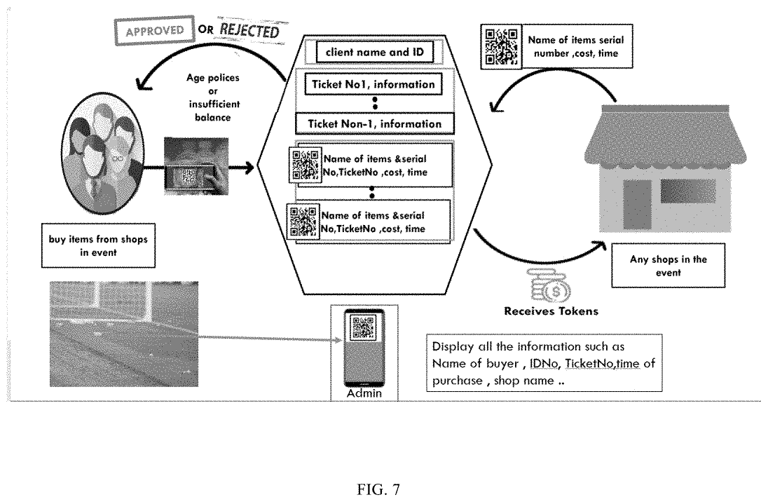

FIG. 7 is a pictorial depiction of an exemplary operation of the token event wallet 102 capable of preventing misdemeanor behavior during the events, in accordance with yet another embodiment of the present disclosure. A user request to buy items via tokens from shops during an event, such as during football match. The user's request may be accepted or rejected based on age policies or insufficient balance. When the user's request is accepted, information associated with the items, such as name of items, serial number, cost and time, are retrieved from the shop via a barcode. Further, the shops receive tokens. Furthermore, the information associated with the items are linked with token ticket of the user, as shown in FIG. 7. For example, client name, ID, and the like is linked with name of items, serial number, ticket number, cost, time and the like. Further, when the user throws any item in the stadium, all the information associated with the user and item, such as name of buyer, ID number, ticket number, time of purchase, shop name and the like, is displayed on admin's smart phone to identify the user. Accordingly, the one or more actions may be taken on the identified user, such as blacklisting the user.

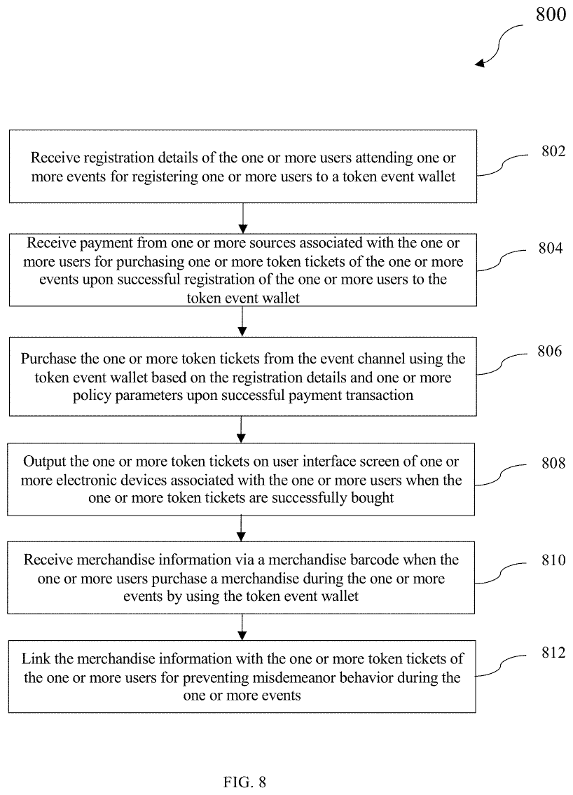

FIG. 8 is a process flow diagram illustrating an exemplary method for preventing misdemeanor behavior during the events, in accordance with an embodiment of the present disclosure. At step 802, registration details of the one or more users attending one or more events are received for registering one or more users to a token event wallet 102. In an embodiment of the present disclosure, the one or more users are users who desires to attend the one or more events. In an exemplary embodiment of the present disclosure, the one or more events corresponds to concerts, sports and the like. For example, the registration details include name, address, age, contact number, verification document, email address of the one or more users and the like. In an embodiment of the present disclosure, the token event wallet 102 is a smart ticket wallet for the one or more events which acts as a middleware between an event channel 106 and payment gateways 104. The token event wallet 102 is developed using blockchain technology.

At step 804, payment is received from one or more sources associated with the one or more users for purchasing one or more token tickets of the one or more events upon successful registration of the one or more users to the token event wallet 102. In an embodiment of the present disclosure, the one or more sources include bank account, debit card, credit card, apple-pay, google pay and the like.

At step 806, the one or more token tickets are purchased from the event channel 106 using the token event wallet 102 based on the registration details and one or more policy parameters upon successful payment transaction. In an embodiment of the present disclosure, the one or more policy parameters include one or more age restrictions, one or more event policies and one or more blacklist restrictions. For example, the one or more age restriction may be that only 18+ crowd is allowed. Further, the one or more event policies may be that only females are allowed. Furthermore, the one or more blacklist restrictions may be that if a user is facing demeanour charges, he is not allowed to participate in the event.

At step 808, the one or more token tickets are outputted on user interface screen of one or more electronic devices 110 associated with the one or more users when the one or more token tickets are successfully bought. The one or more users may show the outputted one or more token tickets at entrance to enter the one or more events. In an exemplary embodiment of the present disclosure, the one or more electronic devices 110 may include a laptop computer, desktop computer, tablet computer, smartphone, wearable device, smart watch and the like.

Further, at step 810, merchandise information is received via a merchandise barcode when the one or more users purchase a merchandise during the one or more events by using the token event wallet 102. In an embodiment of the present disclosure, the merchandise barcode is tagged on the merchandise, such that the shopkeeper scans the merchandise barcode to retrieve the merchandise information. The merchandise information includes name of merchandise, serial number, ticket number, cost, time, shop name and the like. In an exemplary embodiment of the present disclosure, the merchandise may be a bottle, mug, shoes, and the like.

At step 812, the merchandise information is linked with the one or more token tickets of the one or more users for preventing misdemeanor behavior during the one or more events. In an embodiment of the present disclosure, the merchandise barcode of the merchandise bought during the event may be linked with ticket barcode to identify identity of a user in case of any misdemeanor. For example, the misdemeanor behavior may be throwing a plastic bottle or shoe on stage. For example, when a user throws a plastic bottle on the stage, the token event wallet 102 may easily identify identity of the user who purchased the bottle, by retrieving the merchandise information as it is already linked with token ticket of the user. Further, merchandise purchased by a token ticket owner at the event may also be easily identified as it is linked to the token ticket.

In an embodiment of the present disclosure, one or more actions may be performed upon detecting users who performed misdemeanor behavior based on gravity of situation. For example, the detected users are blacklisted or may be handled to respective police department. Further, the one or more users may also sell the bough one or more token tickets by using the token event wallet 102.

The method 800 may be implemented in any suitable hardware, software, firmware, or combination thereof.

Thus, various embodiments of the present invention provide a solution for preventing misdemeanor behavior during the events. In an embodiment of the present disclosure, a connection between the barcode of a merchandise with token ticket of an event is established to identify user in case of misdemeanour. Further, the token event wallet 102 identify merchandise purchased by the ticket owner at the event which is linked to the token ticket. The token event wallet 102 also prevents any misdemeanour, such as throwing bottles, and backlists ticket owners with bad behaviour. In an embodiment of the present disclosure, the token event wallet 102 links any merchandise bought from the stadium or concert or event through their barcode to the ticket barcode so the identity of the person is known in case of any misdemeanour. Furthermore, the token event wallet 102 prevents black market and ticket fraud. In an embodiment of the present disclosure, token event wallet 102 facilitates governance of a new marketplace for buying and selling tickets from their owners without the intervention of event channel 106, with the development of policies under token platform regulations. The channel policy will take percentage of sales. The token event wallet 102 also eases process of purchasing any ticket from any event portals with small changes by adding API (Application Programming Interface) or SDK (Software Development Kit). In an embodiment of the present disclosure, owner of the purchases is known through the ticket number registered inside the wallet to maintain the course of the event without throwing any Bottle. Furthermore, the identity of the ticket buyers is confirmed when entering the events.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (PO) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

We claim:

1. A token event wallet for preventing misdemeanor behavior during events, the token event wallet comprising:
a) at least one hardware processors; and
b) a memory coupled to the at least one hardware processors, wherein the memory comprises a plurality of modules in the form of programmable instructions executable by the at least one hardware processors, and wherein the plurality of modules comprises:
c) a means configured to receive registration details of at least one user attending at least one event for registering the at least one user to a token event wallet;
d) a means configured to receive payment from at least one source associated with the at least one user for purchasing at least one token ticket of the at least one event upon successful registration of the at least one user to the token event wallet;
e) a means configured to purchase the at least one token ticket from an event channel using the token event wallet based on the registration details and at least one policy parameter upon successful payment transaction;
f) a means configured to output the at least one token ticket on a user interface screen of at least one electronic device associated with the at least one user when the at least one token ticket are successfully bought;
g) a means configured to receive merchandise information via a merchandise barcode when the at least one user purchases the merchandise during the at least one event by using the token event wallet; and
h) a means configured to link the merchandise information with the at least one token ticket of the at least one user for preventing misdemeanor behavior during the at least one event.

2. The token event wallet of claim 1, wherein the registration details comprise name, address, age, contact number, verification document and email address of the at least one user.

3. The token event wallet of claim 1, wherein the token event wallet is developed using block chain technology.

4. The token event wallet of claim 1, wherein the at least one source comprises bank account, debit card, credit card, apple-pay and google pay.

5. The token event wallet of claim 1, wherein the at least one policy parameter comprises at least one age restriction, at least one event policy and at least one blacklist restriction.

6. The token event wallet of claim 1, wherein the merchandise information comprises name of merchandise, serial number, ticket number, cost, time and shop name.

7. The token event wallet of claim 1, wherein the at least one electronic device comprises a laptop computer, desktop computer, tablet computer, smartphone, wearable device, and smart watch.

8. The token event wallet of claim 1, further comprises a means configured to perform at least one action upon detecting users who performed misdemeanor behavior based on gravity of situation, wherein the at least one action comprises blacklisting the users and handling the users to respective police department.
